(19) United States
(12) Patent Application Publication
(10) Pub. No.: US 2009/0019387 A1
(43) Pub. Date: Jan. 15, 2009

(54) Display Control of a Tachograph

(75) Inventors: Andreas Lindinger, Flozlingen (DE); Horst Nather, Vilingen-Schwenningen (DE); Werner Schneckenburger, Brigachtal (DE)

Correspondence Address: BAKER BOTTS L.L.P.;PATENT DEPARTMENT, 98 SAN JACINTO BLVD., SUITE 1500, AUSTIN, TX, 78701-4039, US

(73) Assignee: SIEMENS AKTIENGESELLSCHAFT, Munchen (DE)

(21) Appl. No.: 11/913,906

(22) PCT Filed: May 8, 2006
(86) PCT No.: PCT/EP06/62114

§ 371 Date: Nov. 26, 2007

(30) Foreign Application Priority Data
May 12, 2005 (DE) 10 2005 022 115.7

(51) Int. Cl. G06F 3/048

(52) U.S. Cl. 715/771

(57) ABSTRACT

In a method for controlling a display (4) of a tachograph (DTCO) which can be connected to data memories (7) that are associated with defined groups, an ergonomic control of the complex functionality of a digital tachograph is provided while requiring little space. Individual groups are associated with defined functional groups or dialogs of the display (4) and the operational controls (3). The tachograph (DTCO) identifies the group the data memory (7) is associated with and then displays a selection of functional groups that can be selected by means of operational controls (3). The display (4) displays only functions and functional groups that are associated with the group of the data memory (7).

### CROSS-REFERENCE TO RELATED APPLICATIONS

This application is a U.S. national stage application of International Application No. PCT/EP2006/062114 filed May 8, 2006, which designates the United States of America, and claims priority to Germany application number 10 2005 022 115.7 filed May 12, 2005, the contents of which are hereby incorporated by reference in their entirety.

### TECHNICAL FIELD

The invention relates to a method for controlling a display of a tachograph which can be connected in a data-transmitting fashion to at least one data memory, wherein the data memory is assigned to a specific group of a plurality of groups of data memories. In addition, the invention relates to a tachograph having a data memory, having a memory for storing recorded operational data, having an control which controls the display, and having operator control elements, wherein the data memory which can be connected is assigned to a group of a plurality of groups of data memories.

### BACKGROUND

The new generation of tachographs no longer records the person-related operational data on the driving of a vehicle on a paper diagram disk but rather by means of digital storage in a data memory as per EEC Council Regulation no. 3821/85. While the analogue tachograph essentially converted the signal frequency of the rotational speed signal generator, which is arranged in the transmission of the motor vehicle, into a velocity measurement variable and perpetuated it as line on a diagram disk which rotates as time progresses, the new digital tachograph comprises functions which go well beyond those of analogue recording of velocity over time. This involves in particular various possibilities of evaluating and outputting the recorded data. In addition, the digital device also records motor-vehicle-specific data and person-specific-data, for example the tonnage or the personal details. Accordingly, the handling of the device also has to be matched to the extended functional scope. However, in this context there are numerous restrictions on development, making ergonomic implementation of the complex functionality virtually impossible. The restrictions include in particular only a small installation space which is available for the device, only a small front face on which displays and operator control elements have to be arranged, the complex functionality, which has already been explained, and the urgent need for economic viability of the technical solution.

### SUMMARY

Ergonomic control of the complex functionality of a digital tachograph in only a small installation space can be obtained by various embodiments, wherein in one embodiment a method for controlling a display of a tachograph which can be connected in a data-transmitting fashion to at least one data memory, comprises the steps of: —assigning the data memory to a specific group of a plurality of groups of data memories, —assigning specific functions and functional groups of the tachograph or enquiries/queries of a dialogue which is carried out by means of the display and operator control elements to the individual groups, —after a data-transmitting connection to the data memory has been established, identifying the group to which the data memory is assigned by the tachograph, —after the identification, displaying at least one selection possibility as a designation of one of the functional groups or functions which can be selected by means of operator control elements, or displaying a first enquiry/query of the assigned dialogue by the display of the tachograph, —displaying only functions and functional groups or enquiries/queries which are assigned to the group of the data memory by the display, —wherein the display has two lines in which alphanumeric symbols are displayable, and wherein in the first line an information item relating to the ongoing operation of the tachograph or an additional information item relating to a selection possibility which is available for selection is displayed, and in the second line the designation of a function or functional group or a response option to an enquiry/query which can be selected by means of at least one operator control element is displayed.

According to a further embodiment, the display of the designation of the functions or functional groups can be provided in the manner of a multi-level structure, formed from various selection menus, wherein each function or functional group is assigned to at least one selection menu and a functional group or a function is selected by means of at least one operator control element. According to a further embodiment, the display displays at least one of the selection possibilities of a selection menu, and the selection of the selection possibilities which are displayed can be changed by means of operator control elements. According to a further embodiment, the tachograph registers events, events can be assigned to various classes, to each of which a priority is assigned, and the display during the registration of a plurality of events may display an indication of the event with the highest priority. According to a further embodiment, when a fault or a specific event is registered, the display may display an indication of the fault or of the event. According to a further embodiment, a specific data item to which a language can be assigned may be stored in the memory of a data carrier which can be connected to the tachograph, the tachograph assigns a preferred language of the display to this data item, and plain text can be displayed on the display in a form which is adapted to the preferred language. According to a further embodiment, the designations of a function or functional group which are displayed on the display and which can be selected may be displayed in a flashing manner.

According to another embodiment, a tachograph may comprise a display and at least one interface for exchanging data with a data memory, a memory for storing recorded operational data, a control which controls the display, and operator control elements, wherein the data memory is assigned to a group of a plurality of groups of data memories, wherein specific functions and functional groups of the tachograph or enquiries/queries of a dialogue which is carried out by means of the display and the operator control elements are assigned to the groups, the operator control elements interact with the display in such a way that the display displays at least one selection possibility as a designation of one of the functional groups or functions or at least one possible response to an enquiry/queries which are selectable by activating the operator control elements, wherein the tachograph is embodied in such a way that when the data from the data memory is exchanged with the tachograph the tachograph identifies the group to which the data memory is assigned and the control is embodied in such a way that only certain functions and functional groups or enquiries/queries, assigned to the group of the data memory of dialogues which are carried out are selectable for display by means of operator control elements or are displayed by means of the display, and the display comprises two lines in which alphanumeric symbols are displayable, wherein in the first line an information item relating to the ongoing operation of the tachograph or a selection possibility which is available for selection or an enquiry/query is displayed, and in the second line the designation of a function or functional group or a possible enquiry/query response which is selectable and changable by means of at least one operator control element is displayed.

According to a further embodiment of the tachograph, the control may be embodied in such a way that the display of the designation of the functions or functional groups is carried out in the manner of a multi-level structure, formed from various selection menus, wherein each function or functional group is assigned to at least one selection menu, and a functional group or a function is selectable by means of at least one operator control element. According to a further embodiment, the control may be embodied in such a way that events are assigned to various classes, each of which is assigned a priority, and the control controls the display during the registration of a plurality of events in such a way that the display displays an indication of the event with the class with the highest priority. According to a further embodiment, the control may be embodied in such a way that during the registration of a fault or of a specific event, the control may control the display in such a way that the display displays an indication of the fault or of the event. According to a further embodiment, a particular data item to which a language is assignable can be stored in the memory of each data carrier, and the tachograph is embodied in such a way that it assigns a preferred language of the display to this data item and plain text of the display is displayed in the preferred language. According to a further embodiment, the control can be embodied in such a way that the display displays only some, at least one of the selection possibilities of a selection menu or an enquiry/query of the dialogue, and the selection of the selection possibilities or possible responses which are displayed is changable by means of operator control elements. According to a further embodiment, the control can be embodied in such a way that it displays in a flashing manner the designations of a function or functional group or enquiry/query response which are displayed on the display and can be selected.

### BRIEF DESCRIPTION OF THE DRAWINGS

The invention is explained in more detail below by means of a specific exemplary embodiment and with reference to drawings for the sake of clarification. In said drawings:

FIG. 1 shows an arrangement of a tachograph according to an embodiment with a connected sensor,

FIG. 2 shows automatic menu prompting of a tachograph according to an embodiment after a driver's card has been inserted,

FIG. 3 shows automatic menu prompting of a tachograph according to an embodiment after a workshop card has been inserted,

FIG. 4 shows automatic menu prompting of a tachograph according to an embodiment after a monitoring card has been inserted,

FIG. 5 shows automatic menu prompting of a tachograph according to an embodiment after a company card has been inserted, and

FIG. 6 shows an inventive multi-level structure of functions of a tachograph.

### DETAILED DESCRIPTION

The display of the designations of the functions or functional groups can be advantageously provided in the manner of a multi-level structure, formed from various selection menus, wherein each function or functional group is assigned to at least one selection menu and a functional group or a function can be selected by means of at least one operator control element. In this context, a high number of functions can be accommodated in the multi-level structure in an easily viewed fashion, wherein, for example in the first level, the functions are subdivided into superordinate functional groups and in a subsequent level the actual functions can be addressed individually by means of the operator control element. In this context, the display of a single function or functional group on the display field is sufficient. The display of the possibilities for movement can expediently also be by means of the multi-level structure of the operator control menu. A particular advantage of the various embodiments is the adaptation of the display of the tachograph to the identified membership of a group to which the data memory is assigned. In this way it is not always necessary for each option which is associated with the entire functional scope of the tachograph to be represented by means of the display and a higher degree of operator ergonomy can be achieved. In addition, the erroneous attempt to call a function which is not assigned to the corresponding group is ruled out owing to the group not being displayed. Furthermore, it is also not possible for authorization conflicts regarding the execution of specific functions to occur since said conflicts, or the possibility of activation, have already been filtered out owing to the membership of a group.

The display can be embodied in a particularly space-saving fashion if it displays only part, at least one selection possibility, of a selection menu, and the selection of the selection possibilities which are displayed can be changed by means of operator control elements.

In order to make the display as small in format as possible, it is expedient if the events which the tachograph records are assigned to various classes, to each of which a priority is assigned, and the display during the registration of a plurality of events displays an indication of the event with the highest priority. This avoids the landscape format display with unimportant indications being blocked and important indications possibly not being perceived by the user. It is particularly expedient here if when a fault or a specific event is registered, the display displays an indication of the fault or of the event.

The operating comfort of a tachograph according to an embodiment can be additionally increased if a specific data item to which a language can be assigned is stored in the memory of a data carrier which can be connected to the tachograph, the tachograph assigns a preferred language of the display to this data item, and plain text is displayed on the display in a form which is adapted to the preferred language.

Particularly appropriate visualization and prompting of the user is obtained by means of an operator control menu if the display has two lines in which alphanumeric symbols can be represented, wherein in the first line an information item relating to the ongoing operation of the tachograph or an assignment function relating to a selection possibility which is available for selection is displayed, and in the second line the designation of a function or functional group or a response option to an enquiry/query which can be selected by means of at least one operator control element is displayed. In this way, on the one hand, operator control is made easier for the user and, on the other hand, it is possible for the desired function to be found quickly with a display which nevertheless only has a small format. So that the viewer can easily differentiate between the display of an information item and the display of a selection possibility, it is appropriate if the designation of a function or functional group which is displayed on the display and is available for selection is represented in a flashing manner.

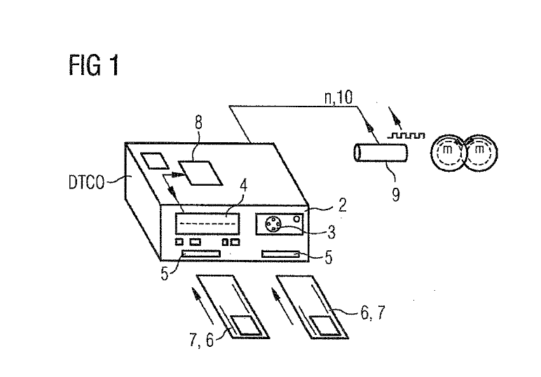

FIG. 1 shows an tachograph DTCO which is embodied in such a way that it has the function in accordance with the an embodiment of a method. The tachograph DTCO has a front panel 2 which is provided with operator control elements 3, a display 4 and plug-in card shafts 5 into which data memories 7 which are embodied as data cards 6 can be inserted. The receptacle shafts 5 accommodate the data cards 6 completely so that they are inaccessible in the tachograph DTCO, in particular during the transmission of data from the outside. The tachograph DTCO has an control 8 for controlling the representation of the display 4. In order to measure the velocity of a motor vehicle, the tachograph DTCO is connected to a sensor 9 which transmits a measurement signal 10, correlated to the velocity, or a rotational speed N of a transmission component both in analogue form and as a digital form to the tachograph DTCO.

The data cards 6 or data memories 7 are assigned to various groups to which specific functions and functional groups of the tachograph, queries, enquiries or dialogues are assigned. In the specific exemplary embodiment, there are data cards 6 for the groups of drivers, workshop, company and monitoring, also referred to below as driver's card, workshop card, company card and monitoring card.

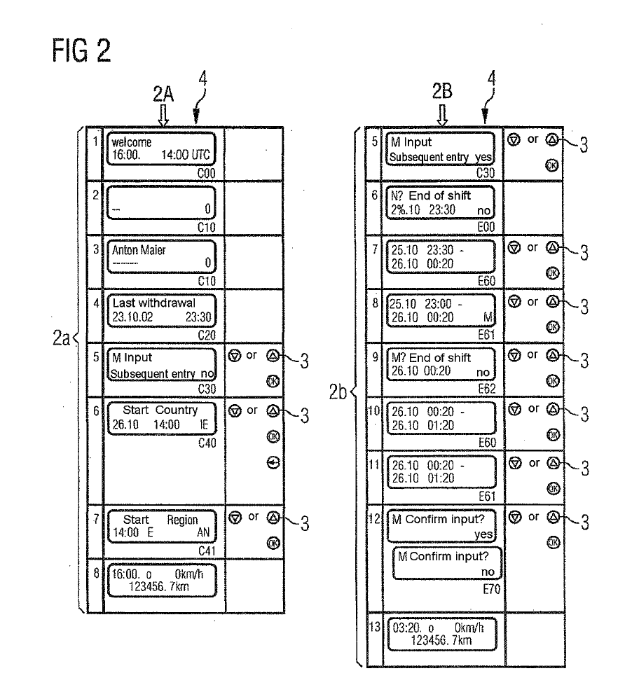

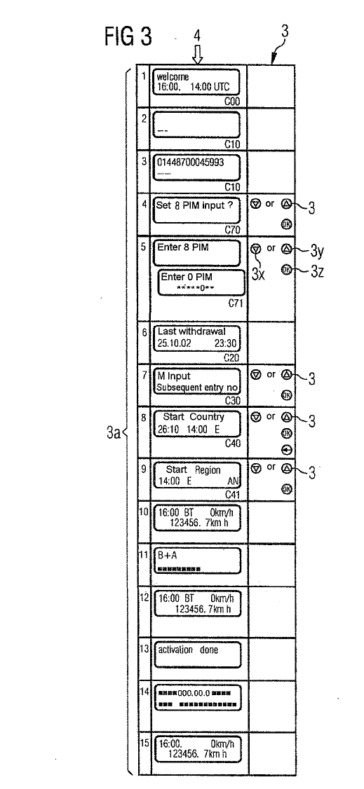

FIG. 2 shows two automatic menu prompts (representations of the display: 2a*, 2b*) and corresponding outputs of the display 4 which are presented to the user when the data card 6 or the data memory 7 which is assigned to the driver is plugged in or connected.

Directly after the data card 6 has been inserted, the display 4 displays a greeting text (representation of the display: 2a1). The data card 6 is then read out and the display 4 symbolizes this by means of the display of two underlines (representation of the display: 2a2). As soon as, during the reading out process, the tachograph DTCO has recorded the personal details of the user assigned to the data card, the complete name (representation of the display: 2a3) is displayed and the sequence bar which is initially represented by means of two underlines has increased to six underlines as the strength has grown. The time when the data card 6 was last withdrawn is then displayed (representation of the display: 2a4). If the driver has activities to record in the interim, he can make an appropriate subsequent entry by means of the operator control elements 3 prompted by the display 4 (representation of the display: 2a5). The subsequent representations of the display 4 (representation of the display: 2a6, 2a7) provide the driver with the possibility of using the operator control elements 3 to enter the country and the region in which he is traveling. As soon as this process is finished, a standard representation (representation of the display: 2a8) appears on the display 4, which represents the time, the speed and the kilometers traveled.

In addition, the menu prompting also provides the driver with the possibility of a manual input procedure. In the specific example, the last time the data card 6 was withdrawn was at 23:30 hours on Oct. 25, 2002, and up to 0:20 hours a first activity occurred and up to 1:20 hours a second activity occurred. In the following operator control step (representation of the display: 2b5), the driver confirms the request of the display 4 for a manual subsequent entry by means of the operator control element 3 with YES and, during the subsequent steps (representation of the display: 2b6 to 2b13) he enters manually the activities which have been carried out.

In this context, he is prompted with information by the display 4 and finally asked, during the step with the representation 2b12, whether the inputs are correct.

Subsequently, the display 4 again displays the standard display (representation of the display: 2b13).

Another image of the display 4 is shown to the user when he enters a data card 6 which is embodied as a workshop card into the tachograph DTCO. After the initial display of a greeting text (presentation of the display: 3a1), the display 4 shows a progress bar which symbolizes the reading of the data card 6, and the display 4 displays a corresponding workshop identifier (representation of the display: 3a3) as soon as the latter has been read out. In order to protect the powerful workshop card functions, there is provision in step (representation of the display: 3a4) to enter a PIN code by means of the operator control elements 3. For this purpose, the number of digits of the PIN code is initially interrogated and the PIN code can subsequently be input by means of the operator control elements 3, the two arrow keys represented 3x, 3y being used for this purpose and a confirmation key 3z acknowledging the termination of the input of the digits of the PIN code. Subsequently, the possibility of inputting a country or a region is provided (representation of the display: 3a6 to 3a8) in a fashion which is analogous to the procedure with the driver's card from FIG. 2 (representation of the display: 2a6, 2a8). The tachograph DTCO automatically starts to connect to the sensor 9 when the workshop card (step 3a11) is first inserted. When the sensor 9 is successfully connected to the tachograph DTCO, the display 4 confirms this with “activation done” (representation of the display: 3a13). This is followed by a restart (representation of the display: 3a14), and finally the standard display (representation of the display: 3a15).

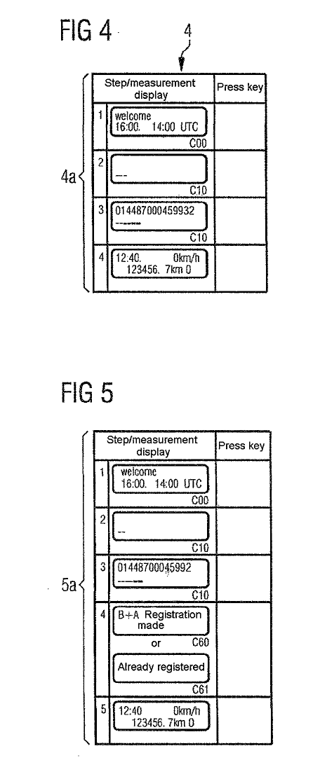

The insertion of a monitoring card by a monitoring element of the respective national executive lead to automatic menu prompting as per FIG. 4. The tachograph DTCO recognizes the group membership of the data card 6 and automatically changes into the “monitoring” operating mode. After the initial greeting text (representation of the display: 4a1), the data card 6 is read (representation of the display: 4a2, 4a3), and a standard display (representation of the display: 4a4) is provided for the “monitoring” operating mode.

In a similar sequence, FIG. 5 shows the various displays 4 after a data card which belongs to the “Company” group has been inserted. When the data card 6 is first connected to the tachograph DTCO, the representation on the display 4 which is designated by 5a4(c60) appears, and the company is automatically registered on the tachograph DTCO. Otherwise, the representation designated by 5a4(c61) appears since the data card 6 is already registered, and automatic registration of the company on the tachograph DTCO to protect company-related data is no longer appropriate.

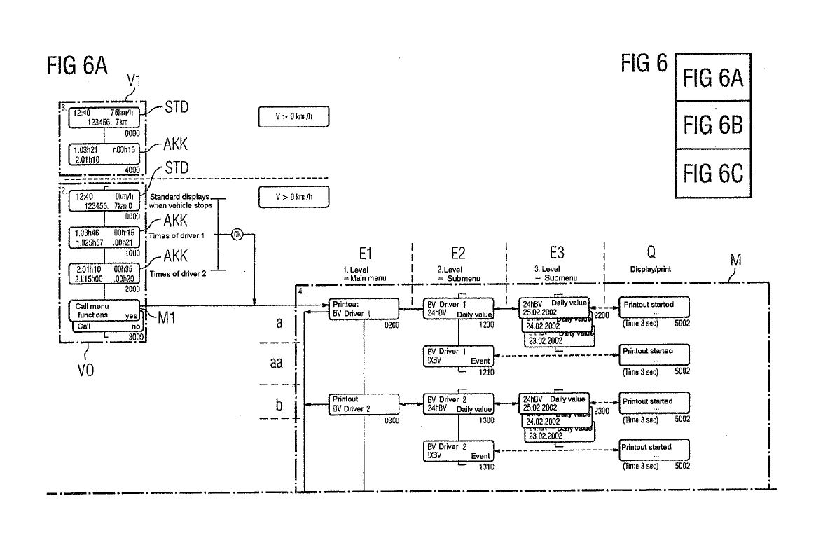

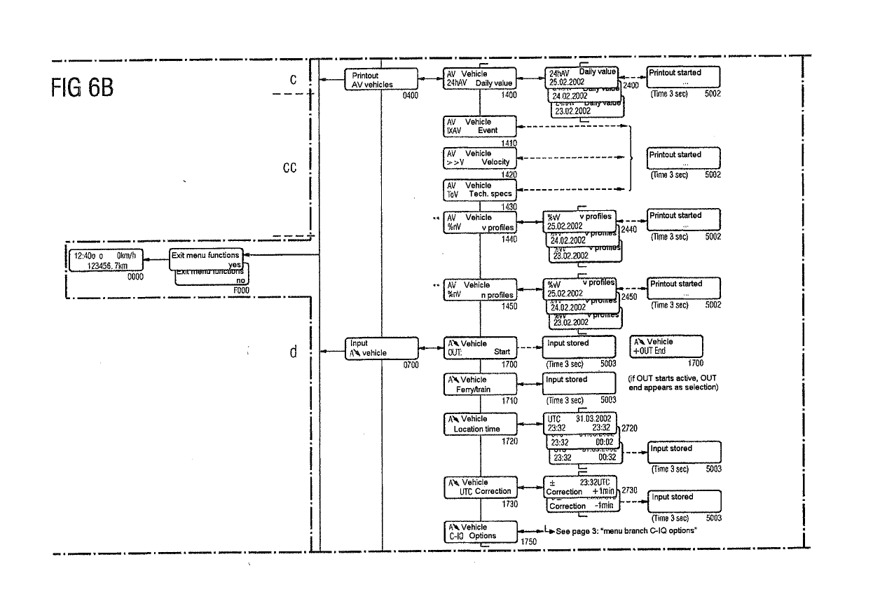

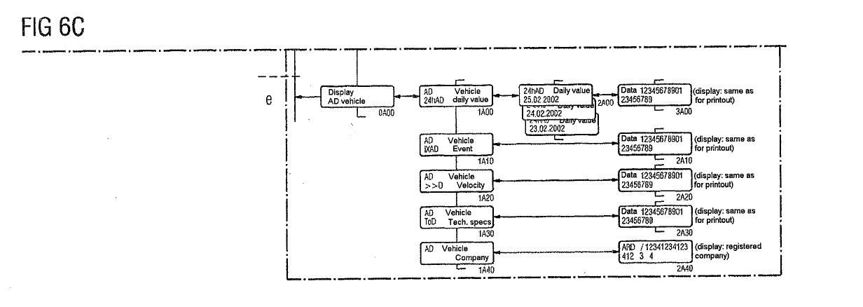

FIG. 6 shows a multi-level structure of a menu-like user prompting system, with the levels (representation of the display in the menu structure M:E1 to representation of the display in the menu structure M:E3) being represented vertically. The actual menu structure is designated by M and is outlined by dashed lines. During the journey, the tachograph DTCO displays a standard display STD, and by pressing on any desired operator control element 3 it is possible to change into a representation of accumulated times AKK. When the vehicle stops, the user is provided with an extended operator control structure V0 in which not only the standard display STD and the display of accumulated times AKK are possible but also menu functions M1 can be called. By means of a confirming pressing action on an operator control element 3, the user moves into the menu structure M. In the first level (representation of the display in the menu structure M:E1), he can select between a printout for a first driver (representation of the display in the menu structure M:E1a), a printout for a second driver (representation of the display in the menu structure M:E1b), a printout for the vehicle (representation of the display in the menu structure M:E1c), an input for the vehicle (representation of the display in the menu structure M:E1d) and a display for the vehicle (representation of the display in the menu structure M:E1e). If the user selects the option of the printout for driver 1 (representation of the display in the menu structure M:E1a), he will find, in the level E2, the selection possibilities of printing out the 24 hour day value (representation of the display in the menu structure M:E2a) and an events list (representation of the display in the menu structure M:E2aa). In the third level E3 he can also specify the printout of the daily value in more detail in terms of the date. During the printout the display 4 acknowledges (Q) the successful selection in the menu structure M. If in the level (representation of the display in the menu structure M:E1), for example the printout for the vehicle (representation of the display in the menu structure M:E1c) is selected, printouts for events which are correlated to the vehicle, the velocity, technical data and a velocity profile (representation of the display in the menu structure M:E2cc) are also available in the level E2 in addition to a printout for the 24 hour day (representation of the display in the menu structure M:E2c). In the case of the velocity profile (representation of the display in the menu structure M:E2c), various days can also be selected again according to the date in the level E3.

What is claimed is:

1. A method for controlling a display of a tachograph which can be connected in a data-transmitting fashion to at least one data memory, the method comprising the steps of:
assigning the data memory to a specific group of a plurality of groups of data memories,
assigning specific functions and functional groups of the tachograph or enquiries of a dialogue which is carried out by means of the display and operator control elements to the individual groups,
after a data-transmitting connection to the data memory has been established, identifying the group to which the data memory is assigned by the tachograph,
after the identification, displaying at least one selection possibility as a designation of one of the functional groups or functions which can be selected by means of operator control elements, or displaying a first enquiry of the assigned dialogue by the display of the tachograph,
displaying only functions and functional groups or enquiries which are assigned to the group of the data memory by the display,
wherein the display has two lines in which alphanumeric symbols are displayable, and wherein in the first line an information item relating to the ongoing operation of the tachograph or an additional information item relating to a selection possibility which is available for selection is displayed, and in the second line the designation of a function or functional group or a response option to an enquiry which can be selected by means of at least one operator control element is displayed.

2. The method according to claim 1, wherein the display of the designation of the functions or functional groups is provided in the manner of a multi-level structure, formed from various selection menus, wherein each function or functional group is assigned to at least one selection menu and a functional group or a function is selected by means of at least one operator control element.

3. The method according to claim 1, wherein the display displays at least one of the selection possibilities of a selection menu, and the selection of the selection possibilities which are displayed can be changed by means of operator control elements.

4. The method according claim 1, wherein the tachograph registers events, events are assigned to various classes, to each of which a priority is assigned, and the display during the registration of a plurality of events displays an indication of the event with the highest priority.

5. The method according to claim 1, wherein when a fault or a specific event is registered, the display displays an indication of the fault or of the event.

6. The method according to claim 1, wherein a specific data item to which a language can be assigned is stored in the memory of a data carrier which can be connected to the tachograph, the tachograph assigns a preferred language of the display to this data item, and plain text is displayed on the display in a form which is adapted to the preferred language.

7. The method according claim 1, wherein the designations of a function or functional group which are displayed on the display and which can be selected are displayed in a flashing manner.

8. A tachograph comprising a display and at least one interface for exchanging data with a data memory, a memory for storing recorded operational data, a control which controls the display, and operator control elements, wherein the data memory is assigned to a group of a plurality of groups of data memories, wherein specific functions and functional groups of the tachograph or enquiries of a dialogue which is carried out by means of the display and the operator control elements are assigned to the groups, the operator control elements interact with the display in such a way that the display displays at least one selection possibility as a designation of one of the functional groups or functions or at least one possible response to an enquiry which are selectable by activating the operator control elements, wherein the tachograph is embodied in such a way that when the data from the data memory is exchanged with the tachograph the tachograph identifies the group to which the data memory is assigned and the control is embodied in such a way that only certain functions and functional groups or enquiries, assigned to the group of the data memory of dialogues which are carried out are selectable for display by means of operator control elements or are displayed by means of the display, and the display comprises two lines in which alphanumeric symbols are displayable, wherein in the first line an information item relating to the ongoing operation of the tachograph or a selection possibility which is available for selection or an enquiry is displayed, and in the second line the designation of a function or functional group or a possible enquiry response which is selectable and changable by means of at least one operator control element is displayed.

9. The tachograph according to claim 8, wherein the control is embodied in such a way that the display of the designation of the functions or functional groups is carried out in the manner of a multi-level structure, formed from various selection menus, wherein each function or functional group is assigned to at least one selection menu, and a functional group or a function is selectable by means of at least one operator control element.

10. The tachograph according to claim 8, wherein the control is embodied in such a way that events are assigned to various classes, each of which is assigned a priority, and the control controls the display during the registration of a plurality of events in such a way that the display displays an indication of the event with the class with the highest priority.

11. The tachograph according to claim 8, wherein the control is embodied in such a way that during the registration of a fault or of a specific event, the control controls the display in such a way that the display displays an indication of the fault or of the event.

12. The tachograph according to claim 8, wherein a particular data item to which a language is assignable is stored in the memory of each data carrier, and the tachograph is embodied in such a way that it assigns a preferred language of the display to this data item and plain text of the display is displayed in the preferred language.

13. The tachograph according to claim 8, wherein the control is embodied in such a way that the display displays only some, at least one of the selection possibilities of a selection menu or an enquiry of the dialogue, and the selection of the selection possibilities or possible responses which are displayed is changable by means of operator control elements.

14. The tachograph according to claim 8, wherein the control is embodied in such a way that it displays in a flashing manner the designations of a function or functional group or enquiry response which are displayed on the display and can be selected.

15. A tachograph comprising:
a display comprising two lines in which alphanumeric symbols are displayable,
at least one interface for exchanging data with a data memory,
a memory for storing recorded operational data,
a control which controls the display, and
operator control elements,
wherein
the data memory is assigned to a group of a plurality of groups of data memories,
specific functions and functional groups of the tachograph or queries which are controlled through a dialogue by means of the display and the operator control elements are assigned to the groups,
the operator control elements interact with the display such that the display displays at least one selection possibility of the functional groups or functions or at least one possible selectable response to a query,
the tachograph is operable such that when the data from the data memory is exchanged with the tachograph the tachograph identifies the group to which the data memory is assigned and the control is operable such that only certain functions and functional groups or queries, assigned to the group of the data memory of dialogues which are carried out are selectable for display by means of operator control elements or are displayed by means of the display, and
wherein in the first line of the display an information item relating to the ongoing operation of the tachograph or a selection possibility which is available for selection or a query is displayed, and in the second line the designation of a function or functional group or a possible response which is selectable by means of at least one operator control element is displayed.

16. The tachograph according to claim 15, wherein the control is embodied in such a way that the display of the designation of the functions or functional groups is carried out in the manner of a multi-level structure, formed from various selection menus, wherein each function or functional group is assigned to at least one selection menu, and a functional group or a function is selectable by means of at least one operator control element.

17. The tachograph according to claim 15, wherein the control is embodied in such a way that events are assigned to various classes, each of which is assigned a priority, and the control controls the display during the registration of a plurality of events in such a way that the display displays an indication of the event with the class with the highest priority.

18. The tachograph according to claim 15, wherein the control is embodied in such a way that during the registration of a fault or of a specific event, the control controls the display in such a way that the display displays an indication of the fault or of the event.

19. The tachograph according to claim 15, wherein a particular data item to which a language is assignable is stored in the memory of each data carrier, and the tachograph is embodied in such a way that it assigns a preferred language of the display to this data item and plain text of the display is displayed in the preferred language.

20. The tachograph according to claim 15, wherein the control is embodied in such a way that the display displays only some, at least one of the selection possibilities of a selection menu or a query of the dialogue, and the selection of the selection possibilities or possible responses which are displayed is changable by means of operator control elements.
